(19) United States
(12) Patent Application Publication
(10) Pub. No.: US 2026/0241721 A1
(43) Pub. Date: Aug. 20, 2026

(54) SHEET CONVEYING APPARATUS, IMAGE READING APPARATUS, AND PRINTING APPARATUS

(71) Applicant: CANON KABUSHIKI KAISHA, Tokyo (JP)

(72) Inventors: KAZUKI MATSUO, Tokyo (JP); TAKUMA TACHIBANA, Kanagawa (JP)

(21) Appl. No.: 19/544,178

(22) Filed: Feb. 19, 2026

(30) Foreign Application Priority Data
Feb. 20, 2025 (JP) 2025-026190

(51) Int. Cl. B41J 13/10; B41J 13/03; H04N 1/00

(52) U.S. Cl. CPC B41J 13/106; B41J 13/03; H04N 1/00588; H04N 1/00602; H04N 1/00604; H04N 1/00631

(57) ABSTRACT

There is provided a technique capable of preventing an increase in work time required to collect discharged sheets. For that purpose, a discharged sheet stacking portion is provided with inclined portions, which are inclined surfaces of which height in a vertical direction increases as advancing in a width direction from the center of the stacking surface in the width direction intersecting with a discharge direction in which the sheet is discharged, and which come into contact with the sheet to be discharged, the inclined portions being provided line-symmetrically with respect to the center of the stacking surface.

### BACKGROUND

### Field of the Technology

The present disclosure relates to a sheet convey device that conveys a sheet subjected to processing, an image reading apparatus, and a printing apparatus.

### Description of the Related Art

Japanese Patent Laid-Open No. 2020-117383 discloses a sheet discharge apparatus including a sheet discharge stopper that restricts movement of discharged sheets in a sheet discharge direction.

However, a configuration disclosed in Japanese Patent Laid-Open No. 2020-117383 does not include means for restricting movement of the discharged sheets in a width direction intersecting with the sheet discharge direction. Therefore, there are problems that work of collecting the discharged sheets becomes complicated and work time increases.

### SUMMARY

Accordingly, the present disclosure provides a technique capable of preventing an increase in work time required to collect discharged sheets.

The present disclosure provides a sheet conveying apparatus including: a conveying unit that conveys a sheet; and a stacking unit including a stacking surface on which the sheet conveyed by the conveying unit and discharged in a first direction is stacked, in which, the stacking unit includes, on both sides in a width direction intersecting with the first direction, first inclined portions having an inclined surface of which height in a vertical direction increases outward from the stacking surface and which is contactable by a sheet to be discharged, and second inclined portions having an inclined surface of which height in the vertical direction increases outward from the first inclined portion and which is contactable by the sheet to be discharged.

According to the present disclosure, it is possible to provide a technique capable of preventing an increase in work time required to collect discharged sheets.

Features of the present disclosure will become apparent from the following description of embodiments with reference to the attached drawings. The following description of embodiments is described by way of example.

### BRIEF DESCRIPTION OF THE DRAWINGS

FIG. 1A is an external perspective view illustrating a multifunction peripheral;

FIG. 1B is an external perspective view illustrating the multifunction peripheral;

FIG. 2A is a view illustrating an image reading apparatus main body;

FIG. 2B is a view illustrating the image reading apparatus main body;

FIG. 3A is a view illustrating a scanner unit;

FIG. 3B is a view illustrating the scanner unit;

FIG. 3C is a view illustrating the scanner unit;

FIG. 4 is a view illustrating a rear surface of a glass-frame unit;

FIG. 5 is a view illustrating an internal configuration of the scanner unit;

FIG. 6A is a perspective view illustrating an ADF unit;

FIG. 6B is a perspective view illustrating the ADF unit;

FIG. 7A is a view illustrating a discharged sheet stacking portion;

FIG. 7B is a view illustrating the discharged sheet stacking portion;

FIG. 7C is a view illustrating the discharged sheet stacking portion;

FIG. 7D is a view illustrating the discharged sheet stacking portion;

FIG. 7E is a view illustrating the discharged sheet stacking portion;

FIG. 8A is a view illustrating a discharged sheet stacking portion;

FIG. 8B is a view illustrating the discharged sheet stacking portion;

FIG. 8C is a view illustrating the discharged sheet stacking portion;

FIG. 9A is a view illustrating a discharged sheet stacking portion;

FIG. 9B is a view illustrating the discharged sheet stacking portion;

FIG. 9C is a view illustrating the discharged sheet stacking portion;

FIG. 10A is a view illustrating a printing apparatus; and

FIG. 10B is a view illustrating the printing apparatus.

### DESCRIPTION OF THE EMBODIMENTS

Embodiments of the present disclosure will be described below with reference to the drawings.

### First Embodiment

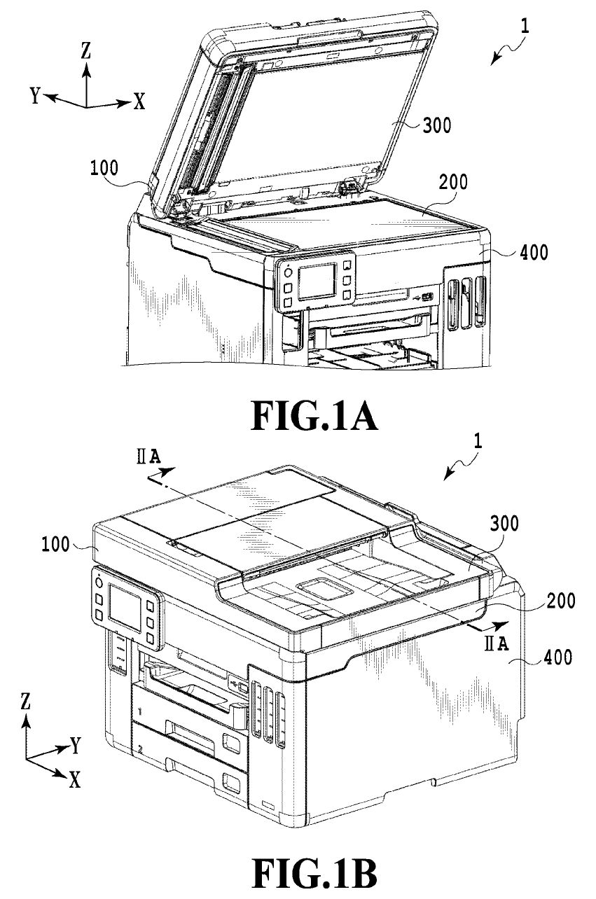

FIGS. 1A and 1B are external perspective views illustrating a multifunction peripheral 1 in which an image reading apparatus main body 100 according to the present invention is combined with a printing apparatus 400, which is an inkjet printer. FIG. 1A illustrates a state in which an automatic direction finder (ADF) unit 300 is open so as to place a sheet as a printing medium on a scanner unit 200, and FIG. 1B illustrates a state in which the ADF unit 300 is closed. The image reading apparatus main body 100 includes an image reading unit 200 (hereinafter, referred to as a scanner unit) and the ADF unit 300. In the following description, a sheet discharge direction is defined as an X direction, and a sheet width direction, which is a direction intersecting the sheet discharge direction, is defined as a Y direction, and a vertical direction is defined as a Z direction.

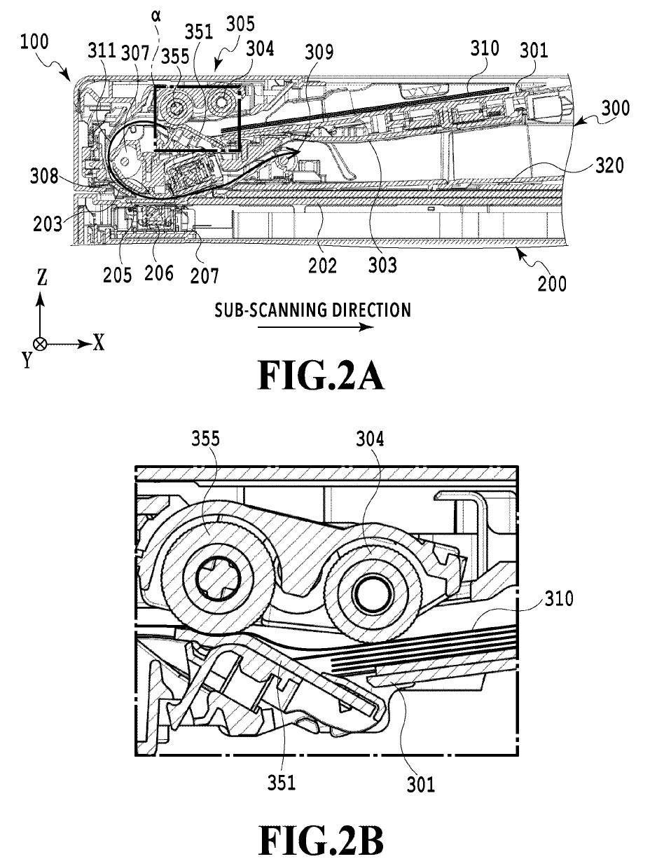

FIG. 2A is a cross-sectional view illustrating the image reading apparatus main body 100 with the ADF unit 300 being closed, and FIG. 2B is an enlarged view of an α-portion in FIG. 2A. An arrow in FIG. 2A indicates a sheet conveyance path 311, which is a path through which sheets are conveyed. A part of the scanner unit 200 is used for a part of the sheet conveyance path 311. The ADF unit 300 includes a sheet placing table 301 on which sheets are placed, a sheet conveying mechanism 305, and a discharged sheet stacking portion 320.

A configuration of the sheet conveying mechanism 305 will be described below, starting an upstream side of the sheet conveyance. The sheet conveying mechanism 305 represents the entire sheet conveying mechanism from a pickup roller 304 to a discharge roller 309. A topmost conveyed sheet 310 out of a plurality of sheets placed on the sheet placing table 301 is conveyed toward a separation roller 355 by a pickup roller 304 of the sheet conveying mechanism 305. Then, the sheet is nipped between the separation roller 355 and a sheet separation portion 351 and conveyed to a conveyance roller 307 on a downstream side. When the conveyed sheet 310 is nipped between the separation roller 355 and the sheet separation portion 351, a succeeding sheet to be conveyed followed by the conveyed sheet 310 abuts against the sheet separation portion 351 and stops by resistance. This configuration makes it possible to separate and convey the sheets one by one.

Next, the conveyed sheet 310 is conveyed to a conveyance guide 203 on the downstream by the conveyance roller 307, and is pressed by a white press plate 308 to bring the conveyed sheet 310 into close contact with an ADF glass 205. At this time, the conveyed sheet 310 is read by an image sensor 206. The white press plate 308 has a size that covers the entire region of the image sensor 206 in the Y direction. The sheet conveying mechanism 305 is provided with various sheet detection sensors, the sheet detection sensor detects a passage of a leading edge and a trailing edge of the sheet, and the output thereof is used to control a reading timing of the image sensor 206.

Examples of sheet reading methods for the image reading apparatus main body 100 include two methods of a sheet-fixed reading method (flatbed reading) and a sheet-conveying reading method (ADF reading). In the sheet-fixed reading method, a sheet is fixed on sheet set table glass 202, and a reading portion 207 moves in the X direction to read the sheet. In the sheet-conveying reading method, the reading portion 207 is fixed at a predetermined position (ADF position), and the sheet is read while being conveyed by the ADF unit 300. The reading portion 207 in the scanner unit 200 in FIG. 2A illustrates a state in which it is waiting at the ADF position in order to read the conveyed sheet 310.

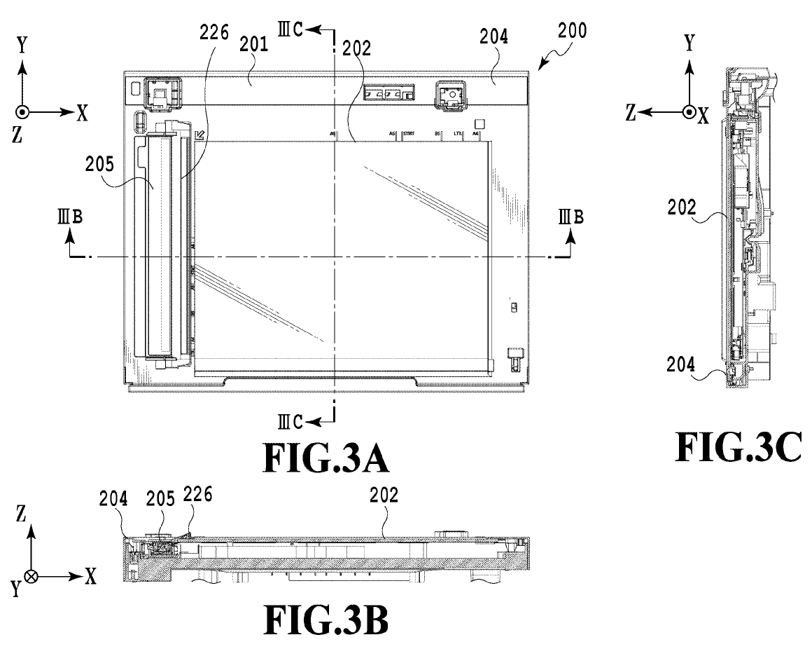

FIG. 3A is a top view of the scanner unit 200 in a state where the ADF unit 300 is removed from the image reading apparatus main body 100 and illustrates a glass-frame portion 201 as a whole. The glass-frame portion 201 includes the sheet set table glass 202 on which a sheet is placed, and a glass frame 204 that holds the ADF glass 205 for reading the sheet. The glass frame 204 includes a sheet-abutting reference 226. FIG. 3B is a cross-sectional view taken along line IIIB - IIIB in FIG. 3A, and FIG. 3C is a cross-sectional view taken along line IIIC - IIIC in FIG. 3A. In the drawings, a white sheet is disposed on a sheet placement surface side of the sheet set table glass 202.

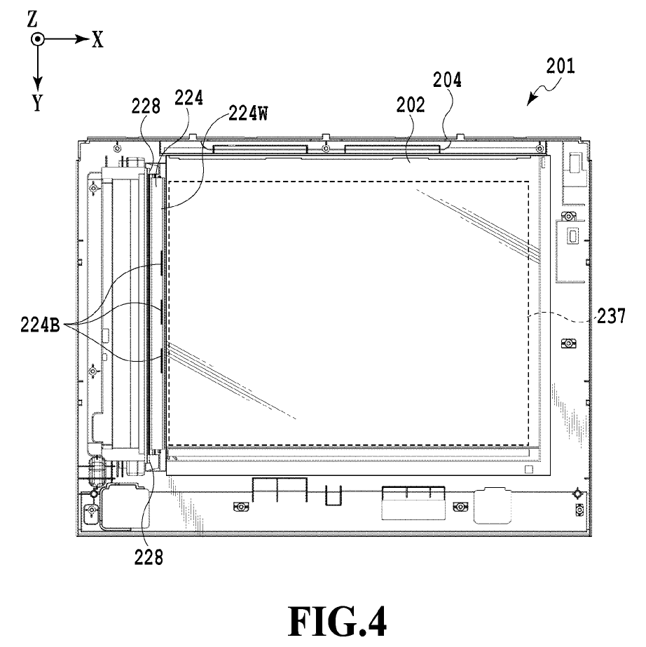

FIG. 4 is a view illustrating a rear surface of the glass-frame portion 201 in FIG. 3A, and illustrates a part of the white sheet 224. The sheet set table glass 202 abuts against two glass-frame abutting portions 228 of the glass frame 204, and thus a position in the X direction thereof is determined. The white sheet 224 is disposed on a back side of the sheet set table glass 202 when viewed from the direction illustrated in the drawing, and the white sheet 224 is disposed on the sheet placement surface.

In FIG. 4, the white sheet 224 is positioned in the X direction between the glass-frame abutting portion 228 and a stationary sheet reading area 237. The white sheet 224 integrally includes a white region 224W for performing shading correction for the image sensor and a black region 224B that serves as a reference position in the X direction of the image sensor 206 (see FIG. 2A). In order to perform shading processing, the white sheet 224 has such a size that covers the entire region in the Y direction of the image sensor 206. The position in the X direction of the black region 224B in the white sheet 224 is formed on a side closer to the stationary sheet reading area 237 than the white region 224W.

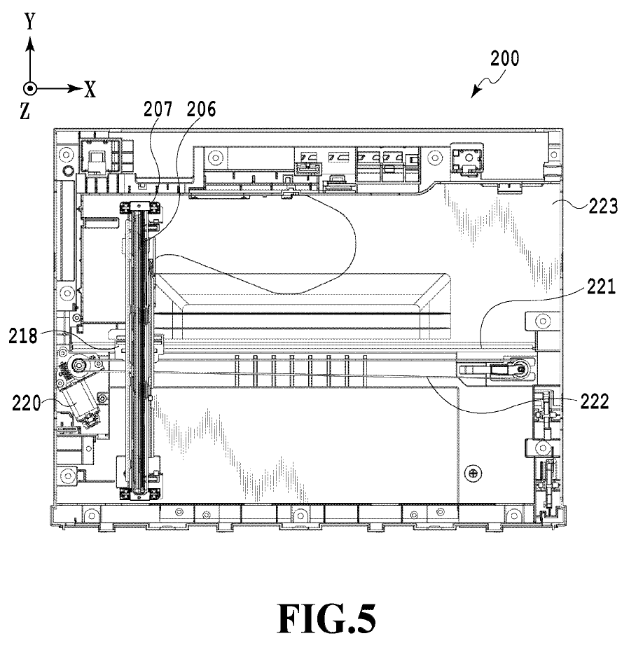

FIG. 5 is a view illustrating the scanner unit 200 in a state where the glass-frame portion 201 is removed from the top view illustrated in FIG. 3A to show an internal configuration of the scanner unit 200. The arrangement of the reading portion 207 and a base frame 223 can be seen in FIG. 5. A guide rail 221 is disposed at approximately a center in the Y direction of the base frame 223, with its longitudinal direction as the X direction. A slider 218 of the reading portion 207 mounted with the image sensor 206 is disposed on the guide rail 221 so as to be slidable in the X direction. When a driving input is input to a motor 220, a belt 222 moves in response to the input, and the reading portion 207 scans back and forth along the guide rail 221 via a drive transmission unit to which the belt 222 is connected. In the present embodiment, the reading unit has a belt-drive type in which the drive portion is disposed on the base frame 223 and a driving force is transmitted by the belt, but may have a self-scanning type in which the drive portion is disposed on the reading portion 207.

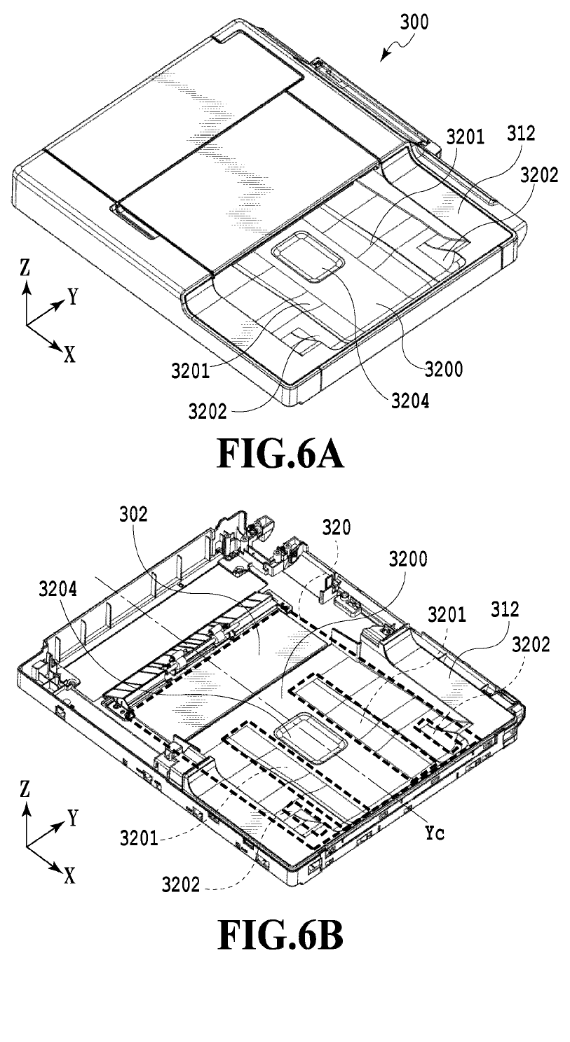

FIG. 6A is a perspective view illustrating the ADF unit 300, and FIG. 6B is a perspective view illustrating the discharged sheet stacking portion 320. The discharged sheet stacking portion 320 in the present embodiment includes an ADF base 302 and a discharged sheet stacking tray 312 as illustrated in FIG. 6B. The discharged sheet stacking portion 320 includes a stacking surface 3200, a first inclined portion 3201, and a second inclined portion 3202.

There are two first inclined portions 3201, one of which includes an inclined surface whose height in the Z direction increases toward the Y direction from a center Yc of the stacking surface 3200 in the Y direction, and the other of which includes an inclined surface whose height in the Z direction increases toward a - Y direction.

There are two second inclined portions 3202 located further from the center Yc compared to the first inclined portion 3201, one of which includes an inclined surface whose height in the Z direction increases toward the Y direction from the center Yc of the stacking surface 3200 in the Y direction stacking surface 3200. The other inclined portion includes an inclined surface whose height in the Z direction increases toward the - Y direction. The two first inclined portions 3201 are provided line-symmetrically with respect to the center Yc, and the two second inclined portions 3202 are provided line-symmetrically with respect to the center Yc.

Furthermore, the second inclined portion 3202 is located higher in the Z direction than the first inclined portion 3201, and the highest position in the Z direction of the first inclined portion 3201 is the lowest position in the Z direction of the second inclined portion 3202. In other words, the first inclined portion 3201 and the second inclined portion 3202 are configured to be higher in this order. Both of the first inclined portion 3201 and the second inclined portion 3202 include inclined surfaces being curved that are convex in a direction having a component in a - Z direction. The stacking surface 3200 includes a recessed portion 3204, and the recessed portion 3204 is configured to be recessed in the - Z direction from the stacking surface 3200.

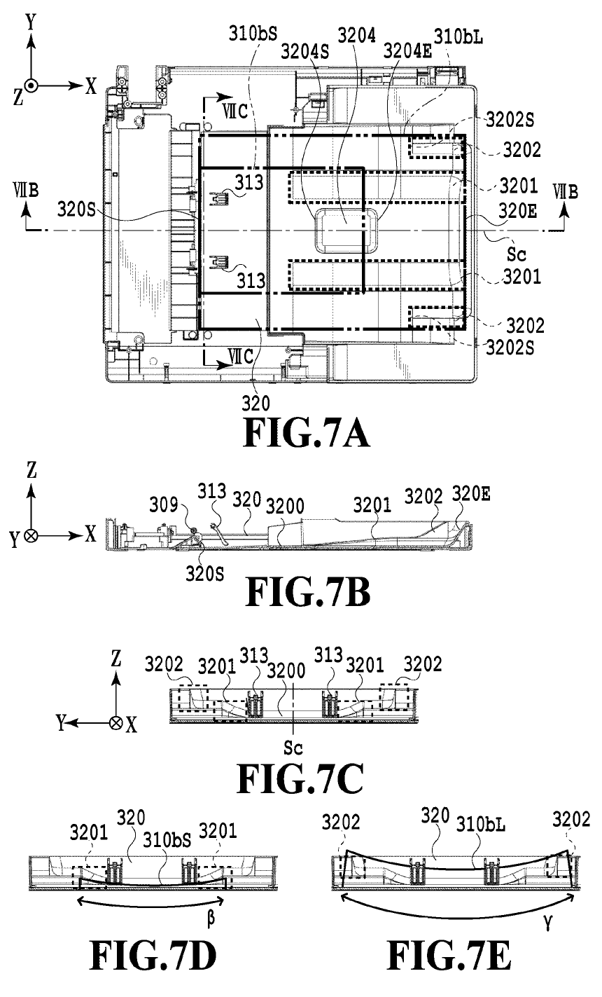

FIG. 7A is a view illustrating a top surface of the discharged sheet stacking portion 320, and FIG. 7B is a cross-sectional view taken along line VIIB - VIIB in FIG. 7A. In the X direction, which is the sheet discharge direction, a small-sized sheet 310bS and a large-sized sheet 310bL discharged to the discharged sheet stacking portion 320 are discharged such that trailing edges thereof are located near an upstream end 320S of the discharged sheet stacking portion 320.

A positional relationship between the discharge roller 309 and the discharged sheet stacking portion 320 will be described herein. In the X direction, which is the sheet discharge direction, the discharge roller 309, a sheet flapper 313, the stacking surface 3200, the first inclined portion 3201 (broken line portion), and the second inclined portion 3202 (broken line portion) are disposed in this order from an upstream side to a downstream side. In the X direction, an upstream end 3201S of the first inclined portion 3201 is located on an upstream side from a leading edge of the discharged small-sized sheet 310bS, and a downstream end of the first inclined portion 3201 is connected to a downstream end 320E of the discharged sheet stacking portion 320.

In the X direction, an upstream end 3204S of the recessed portion 3204 is located on the upstream side from the leading edge of the discharged small-sized sheet 310bS. A downstream end 3204E of the recessed portion 3204 is located between the leading edge of the discharged small-sized sheet 310bS and the downstream end 320E of the discharged sheet stacking portion 320. In other words, the recessed portion 3204 is provided at a position that overlaps the leading edge of the discharged small-sized sheet 310bS in the X direction. Thus, when a user takes out the discharged small-sized sheet 310bS, the user can easily take it out of the recessed portion 3204. In addition, the recessed portion 3204 may be provided in a hole shape instead of a recessed shape. In the X direction, an upstream end 3202S of the second inclined portion 3202 is located closer to the downstream end 320E than the upstream end 320S of the discharged sheet stacking portion 320, and the downstream end of the second inclined portion 3202 is connected to the downstream end 320E of the discharged sheet stacking portion 320.

The sheet flapper 313 is attached to a frame member 303 (see FIG. 2A), and acts to press down the sheet discharged from the discharge roller 309 in the - Z direction. In the Y direction, the sheet flapper 313 is provided at a position that overlaps the inclined surface of the first inclined portion 3201 from the inside of the first inclined portion 3201. In order to prevent the small-sized sheet 310bS and the large-sized sheet 310bL from floating from the discharged sheet stacking portion 320, the sheet flapper 313 is disposed near the end of the small-sized sheet 310bS in the Y direction.

FIG. 7C is a cross-sectional view taken along line VIIC - VIIC in FIG. 7A. The sheet flapper 313, the first inclined portion 3201, and the second inclined portion 3202 are disposed in this order in the ± Y direction from a center SC in a sheet width direction in the Y direction.

FIG. 7D is a cross-sectional view taken along line VIIC - VIIC in FIG. 7A in a state in which the small-sized sheet 310bS is stacked on the discharged sheet stacking portion 320. Both ends of the discharged small-sized sheet 310bS come into contact with the first inclined portion 3201, and the small-sized sheet 310bS is curved in a direction of arrow β and stacked.

FIG. 7E is a cross-sectional view taken along line VIIC - VIIC in FIG. 7A in a state in which the large-sized sheet 310bL is stacked on the discharged sheet stacking portion 320. Both ends of the discharged large-sized sheet 310bL come into contact with the second inclined portion 3202, and the large-sized sheet 310bL is curved in a direction of arrow γ and stacked.

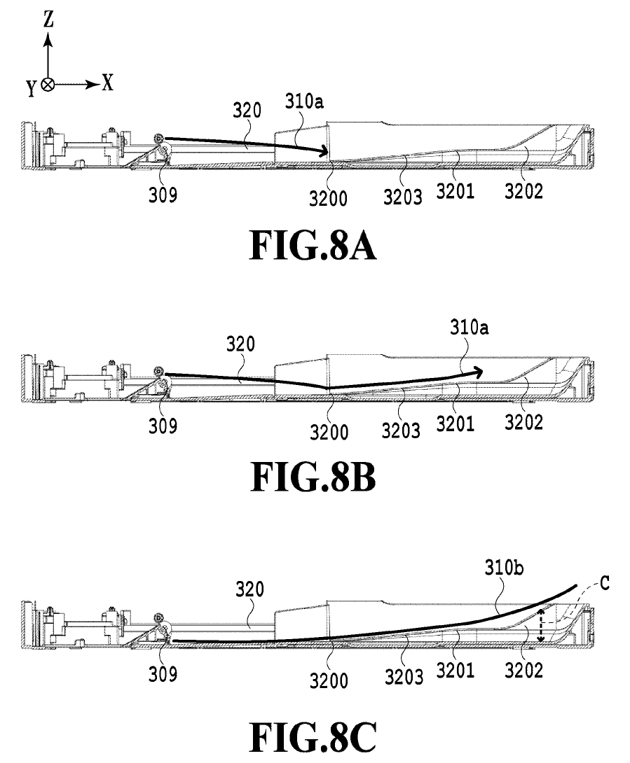

FIGS. 8A and 8B are cross-sectional views taken along VIIB-VIIB in FIG. 7A when a conveyed sheet 310a is discharged in the X direction by the discharge roller 309 and a stacked sheet 310b is stacked on the discharged sheet stacking portion 320. FIG. 8C is a cross-sectional view taken along line VIIB - VIIB in FIG. 7A when the stacked sheet 310b discharged by the discharge roller 309 is placed on the discharged sheet stacking portion 320. In FIGS. 8A to 8C, for convenience, the conveyed sheet 310a being conveyed is indicated by a solid line with an arrow, the stacked sheet 310b, which has already been discharged and stacked, is indicated by a solid line without an arrow, and the sheet flapper 313 is not illustrated. The large-sized sheet 310bL will be described herein as an example.

A leading edge of the conveyed sheet 310a to be conveyed from the discharge roller 309 first abuts against the stacking surface 3200 as illustrated in FIG. 8A, and then abuts against the second inclined portion 3202 by passing through the first inclined portion 3201 as illustrated in FIG. 8B. Thereafter, as illustrated in FIG. 8C, when the trailing edge of the conveyed sheet is discharged from the discharge roller 309, the stacked sheet 310b is placed on the discharged sheet stacking portion 320, and the discharge to the discharged sheet stacking portion 320 is completed. Through a series of operations in FIGS. 8A to 8C, the conveyed sheet 310a is discharged to the discharged sheet stacking portion 320 and placed as the stacked sheet 310b. As illustrated in FIG. 8C, there is a clearance C in the Z direction between the stacked sheet 310b and the stacking surface 3200, and thus the user can easily take out the stacked sheet 310b.

The discharged sheet stacking portion 320 is formed with a third inclined portion 3203 that is an inclined surface of which height in the Z direction increases as advancing in the X direction over the first inclined portion 3201 and the second inclined portion 3202 from the stacking surface 3200 against which the leading edge of the conveyed sheet 310a discharged from the discharge roller 309. The stacked sheet 310b discharged and stacked is curved in the X direction and placed by the third inclined portion 3203, as illustrated in FIG. 8C. When the third inclined portion 3203 is provided in this way, a force in the + Z direction and a force in the - X direction act on the conveyed sheet 310a to be discharged from the discharge roller 309. The force in the - X direction acts on the conveyed sheet 310a, and thus movement in the X direction of the conveyed sheet 310a is restricted.

The first inclined portion 3201, the second inclined portion 3202, and the third inclined portion 3203 are provided in the discharged sheet stacking portion 320 in this way, and thus a posture of the stacked sheet 310b stacked on the discharged sheet stacking portion 320 can be controlled as follows.

In the X direction, which is the sheet discharge direction, the stacked sheet 310b can be stacked in the vicinity of the discharge roller 309 according to the shape of the stacking surface 3200. At a position away from the discharge roller 309, the stacked sheet 310b can be stacked according to the shape of the first inclined portion 3201 or the second inclined portion 3202 that restricts movement in the Y direction. In other words, at the position away from the discharge roller 309 in the X direction, the small-sized sheet 310bS can be stacked by being curved in the Y direction according to the shape of the first inclined portion 3201, and the large-sized sheet 310bL can be stacked by being curved in the Y direction according to the shape of the second inclined portion 3202.

As a result, it is possible to prevent both of the small-sized sheet 310bS and the large-sized sheet 310bL from being shifted in the Y direction, which is a sheet width direction, and in the X direction which is a sheet conveying direction.

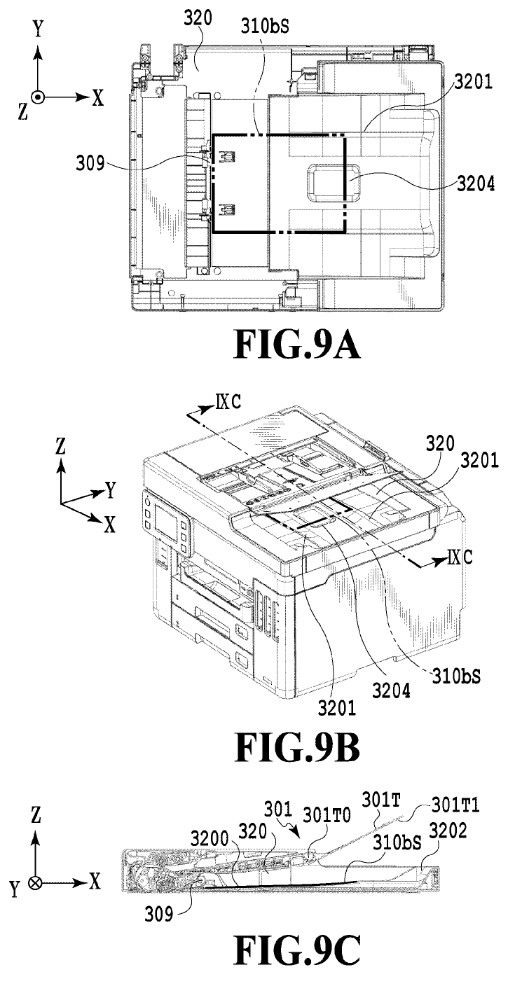

FIG. 9A is a top view illustrating a positional relationship between the discharged sheet stacking portion 320 and the stacked sheet in the present embodiment, and FIG. 9B is a perspective view illustrating a positional relationship between the multifunction peripheral 1 and the stacked sheet in the present embodiment. The discharged sheet stacking portion 320 includes the first inclined portions 3201 on both ends of the sheet to be discharged in the Y direction, which is the sheet width direction, and includes the recessed portion 3204 in the center thereof. When the small-sized sheet 310bS is stacked on the discharged sheet stacking portion 320, the user can easily take out the small-sized sheet 310bS on the discharged sheet stacking portion 320 by putting hand in the recessed portion 3204.

FIG. 9C is a cross-sectional view taken along line IXC - IXC in FIG. 9B. FIG. 9 C illustrates a state in which a fed sheet stacking tray 301T attached to the sheet placing table 301 is in use and the small-sized sheet 310bS is stacked on the discharged sheet stacking portion 320. The fed sheet stacking tray 301T is configured to be rotatable relative to the sheet placing table 301 around the fed sheet stacking tray-rotational center 301T0. In the X direction, which is the sheet discharge direction, the fed sheet stacking tray-rotational center 301T0 is located between the discharge roller 309 and the second inclined portion 3202, and the fed sheet stacking tray 301T in use is inclined with respect to the stacking surface 3200. This configuration ensures a large space for the user to take out the small-sized sheet 310bS.

In the Z direction, the fed sheet stacking tray-rotational center 301T0 is located above the discharge roller 309, and is positioned so as not to interfere with the discharge of sheet. In the X direction, a fed sheet stacking tray end 301T1 in use is configured to fit in a device size. For this reason, the fed sheet stacking tray end 301T1 does not limit the device size, and can be used in a small space even in use.

An example has been described in the present embodiment in which both of the first inclined portion 3201 and the second inclined portion 3202 include the inclined surface being curved, but the present invention is not limited thereto. The first inclined portion 3201 and the second inclined portion 3202 may be flat inclined surfaces.

As described above, the discharged sheet stacking portion 320 is provided with the inclined portions, which are the inclined surfaces of which height in the vertical direction increases as advancing in the width direction from the center of the stacking surface in the width direction intersecting with the discharge direction in which the sheet is discharged, and which come into contact with the sheet to be discharged, the inclined portions being provided line-symmetrically with respect to the center of the stacking surface. This makes it possible to provide a technique capable of preventing an increase in work time required to collect the discharged sheets.

### Another Embodiment

Another embodiment of the present disclosure will be described below with reference to the drawings. The basic configuration of the present embodiment is the same as that of the first embodiment, and thus only a characteristic configuration will be described. In the above-described embodiment, the present disclosure has been described using the multifunction peripheral 1 as an example. In the present embodiment, a configuration will be described to which the present disclosure is applied to a printing apparatus 400.

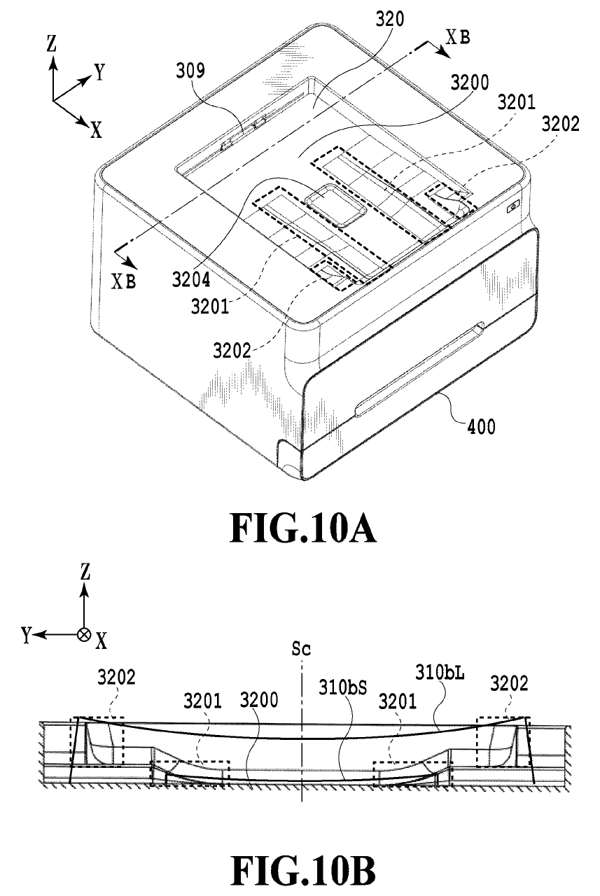

FIGS. 10A and 10B are views illustrating the present embodiment, and FIG. 10A is a perspective view illustrating a printing apparatus 400. The printing apparatus 400 conveys a sheet, which is a printing medium, to a printing unit, and discharges the sheet after printing to a discharge portion. In the X direction, which is the sheet discharge direction, a discharge roller 309, a stacking surface 3200, a first inclined portion 3201, and a second inclined portion 3202 are disposed in this order from an upstream side to a downstream side. FIG. 10B is a cross-sectional view taken along line XB - XB in FIG. 10A. In the Y direction, the stacking surface 3200, the first inclined portion 3201, and the second inclined portion 3202 are disposed in this order from the center SC in the sheet width direction (Y direction).

In other words, at a position away from the discharge roller 309 in the X direction, the small-sized sheet 310bS can be stacked by being curved according to the shape of the first inclined portion 3201, and the large-sized sheet 310bL can be stacked by being curved according to the shape of the second inclined portion 3202. Thus, it is possible to prevent both of the small-sized sheet 310bS and the large-sized sheet 310bL from being shifted in a sheet width direction EWD.

As described above, the present disclosure can also be applied to a printing apparatus, and the present disclosure can also be further applied to a sheet convey device that conveys processed sheets, in addition to the printing apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-026190, filed February 20, 2025, which is hereby incorporated by reference herein in its entirety.

What is claimed is:

1. A sheet conveying apparatus comprising:
a conveying unit that conveys a sheet; and
a stacking unit including a stacking surface on which the sheet conveyed by the conveying unit and discharged in a first direction is stacked, wherein
the stacking unit includes, on both sides in a width direction intersecting with the first direction, first inclined portions having an inclined surface of which height in a vertical direction increases outward from the stacking surface and which is contactable by a sheet to be discharged, and second inclined portions having an inclined surface of which height in the vertical direction increases outward from the first inclined portion and which is contactable by the sheet to be discharged, and
the second inclined portion is provided at a position higher in the vertical direction than the first inclined portion.

2. The sheet conveying apparatus according to claim 1, wherein
the first inclined portion is provided to come into contact with both ends in the width direction of a first sheet to be discharged, and the second inclined portion is provided to come into contact with both ends in the width direction of a second sheet that is wider in the width direction than the first sheet.

3. The sheet conveying apparatus according to claim 2, wherein
the first inclined portion has a length longer than that of the second inclined portion in the first direction.

4. The sheet conveying apparatus according to claim 3, further comprising:
a tray that rotates on a rotational axis and stacks the sheet conveyed by the conveying unit; and
a discharge roller that discharges the sheet conveyed by the conveying unit, wherein
the rotational axis is located between the discharge roller and the second inclined portion.

5. The sheet conveying apparatus according to claim 3, wherein
a recessed portion is provided between the two first inclined portions, which is recessed in the vertical direction from the stacking surface, and the recessed portion is provided at a position in the first direction that overlaps a leading edge in the first direction of the first sheet discharged and stacked.

6. The sheet conveying apparatus according to claim 5, wherein
the recessed portion is located on an upstream side from the second inclined portion in the first direction.

7. The sheet conveying apparatus according to claim 1, wherein
the stacking unit includes a plurality of sheet flappers that press down the discharged sheet in the vertical direction.

8. The sheet conveying apparatus according to claim 1, wherein
the stacking surface includes a third inclined portion that is an inclined surface of which height in the vertical direction increases as advancing in the first direction.

9. The sheet conveying apparatus according to claim 1, wherein
the first inclined portion and the second inclined portion are curved.

10. An image reading apparatus comprising:
a sheet conveying apparatus according to claim 1; and
a reading unit that reads an image of an original, which is a sheet conveyed by the conveying unit, wherein
the sheet read by the reading unit is discharged to the stacking unit.

11. A printing apparatus comprising:
a sheet conveying apparatus according to claim 1; and
a printing unit that prints an image on a sheet conveyed by the conveying unit, wherein
the sheet printed by the printing unit is discharged to the stacking unit.
